(19) United States
(12) Patent Application Publication
(10) Pub. No.: US 2025/0215844 A1
(43) Pub. Date: Jul. 3, 2025

(54) FAULT DIAGNOSIS METHOD AND DEVICE FOR EVAPORATED FUEL PROCESSING DEVICE

(71) Applicant: NISSAN MOTOR CO., LTD., Yokohama-shi, Kanagawa (JP)

(72) Inventor: Hironari TANO, Kanagawa (JP)

(73) Assignee: NISSAN MOTOR CO., LTD., Yokohama-shi, Kanagawa (JP)

(21) Appl. No.: 18/852,087

(22) PCT Filed: Mar. 31, 2022
(86) PCT No.: PCT/JP2022/016424

§ 371 Date: Sep. 27, 2024

(51) Int. Cl. F02M 25/08

(52) U.S. Cl. CPC F02M 25/0809; F02M 25/0836

(57) ABSTRACT

A fault diagnosis technique for two purge control valves in an evaporated fuel processing device is provided. Diagnosis is performed in first and second stages. The diagnosis for the first stage is performed during normal purging to determine whether a purge passage pressure when the two purge control valves are both controlled into an open state is equal to or lower than a first threshold value. When the purge passage pressure is higher than first threshold value, a counter is incremented, and when the counter value reaches a predetermined value, a fault is determined, and the diagnosis for the second stage is performed. In the second stage, the purge control valves are forcibly controlled into an open state one by one, and it is determined whether the purge passage pressure is equal to or lower than a second threshold value. The fault location can then be identified.

### TECHNICAL FIELD

The present invention relates to a fault diagnosis method and a fault diagnosis device for diagnosing a fault such as fixed-closure of a plurality of purge control valves, in an evaporated fuel processing device in which a canister is used.

### BACKGROUND TECHNOLOGY

An evaporated fuel processing device has been widely used hitherto in which evaporated fuel generated in a fuel tank of a vehicle is temporarily adsorbed to a canister formed by using an adsorbent such as activated carbon, following which, during the operation of an internal combustion engine, fuel components are purged from the canister by introducing new air so as to be introduced into an intake system of the internal combustion engine, in order to suppress the evaporated fuel from flowing out to the outside.

In a patent document 1, there is disclosed that, in an evaporated fuel processing device equipped with two purge control valves arranged in parallel with each other in a purge passage, by individually operating the two purge control valves, fault diagnosis (for example, diagnosis for fixed-closure) of the individual purge control valves is performed. If the pulsation of the internal pressure of the tank is not detected when one purge control valve is operated at a proper on-duty ratio, it is determined that the purge control valve causes a fault. Such a diagnosis is successively performed to the two purge control valves.

However, in order to perform such fault diagnosis, when only one of the purge control valves is operated and the other of the purge control valves is kept in a non-operation state, during that period, the amount of purge gas which flows from a canister into an intake system of the internal combustion engine is reduced by substantially half, and it causes delay in processing for the fuel components adsorbed in the canister. Then, such a problem becomes more remarkable when the fault diagnosis is frequently performed.

### PRIOR ART REFERENCE(S)

### Patent Documents(S)

Patent Document 1: Japanese Patent Application Publication No. 2008-215287

### SUMMARY OF THE INVENTION

The present invention is fault diagnosis for an evaporated fuel processing device in which a plurality of purge control valves are disposed in a purge passage between a canister and an internal combustion engine so as to be arranged in parallel with each other, and a first diagnosis for a purge system is performed based on the pressure of the purge passage at the time when the plurality of the purge control valves are all controlled into an open state, and when a fault is determined in the purge system in the first diagnosis, a second diagnosis for identifying a fault location is performed, by controlling the plurality of the purge control valves into an open state one by one, based on the purge pressure passage in each state.

The second diagnosis is not performed unless a certain fault is determined in the first diagnosis. Therefore, the restriction of purging from the canister to the intake system for the fault diagnosis is minimized.

### BRIEF DESCRIPTION OF THE DRAWINGS

FIG. 1 is an illustrative view of the configuration of an evaporated fuel processing device to which a fault diagnosis in one embodiment is applied.

FIG. 2 is a time chart showing a purge passage pressure and the like in the fault diagnosis.

FIG. 3 is an illustrative view collectively showing individual diagnosis and the final diagnosis result.

### MODE FOR IMPLEMENTING THE INVENTION

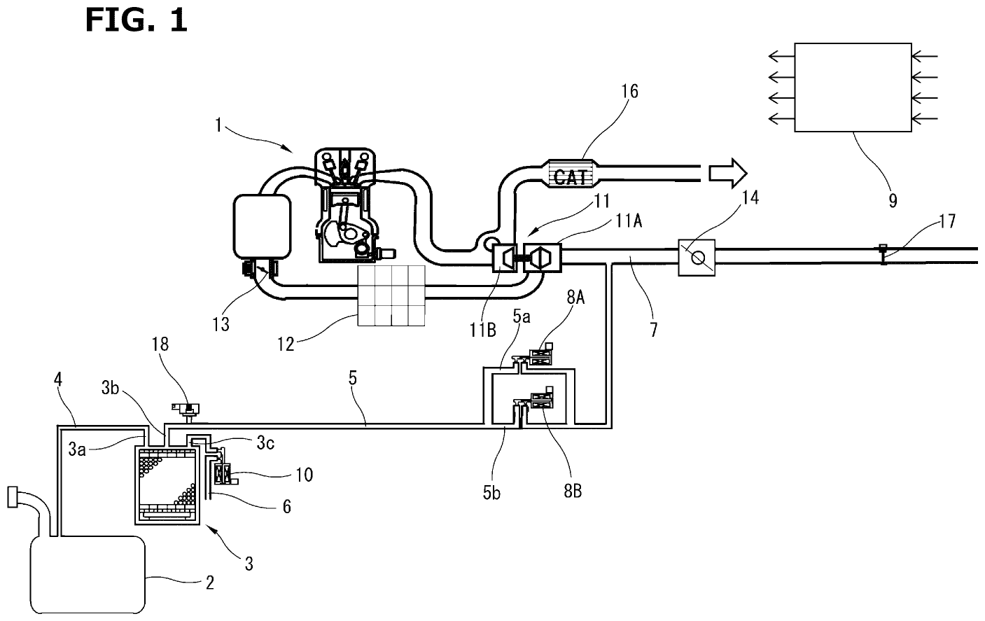

In the following, one embodiment of the present invention will be explained in detail based on the drawings. FIG. 1 is a configuration illustrative view showing the configuration of an evaporated fuel processing device to which a fault diagnosis in one embodiment of the present invention is applied. In one embodiment, a vehicle is a so-called series hybrid vehicle traveling with a motor, and an internal combustion engine 1 is one for generating power for driving a generator. That is, the operation and stoppage of internal combustion engine 1 are repeated according to a power request based on an SOC and the like of a battery, and during the operation, internal combustion engine 1 is basically operated under a specific driving condition (load and rotation speed) of becoming the best fuel consumption.

The evaporated fuel processing device is one for processing evaporated fuel generated in a fuel tank 2 of the vehicle, for example, during stop of the vehicle without flowing out to the outside, and is configured of a canister 3 as a main body in which an adsorbent such as activated carbon for temporarily storing the evaporated fuel is filled. Canister 3 includes a charge port 3a and purge port 3b at one end of an internal flow passage, and is provided with a drain port 3c at the other end. Charge port 3a is communicated with the upper space of a fuel tank 2 via a charge passage 4, and purge port 3b is communicated with an intake passage 7 of internal combustion engine 1 via a purge passage 5. In addition, drain port 3c is opened to the atmosphere via a drain passage 6. Drain passage 6 is provided with a drain cut valve 10 formed by an electromagnetic valve which is capable of closing drain passage 6 to seal the inside of the system at the time of a leakage diagnosis and the like.

For example, evaporated fuel generated during the stop of the vehicle or refueling is introduced into canister 3 via charge passage 4 and is adsorbed by an adsorbent of each part while flowing to drain port 3c through the adsorbent. The fuel components adsorbed in this way are purged from the adsorbent by taking the atmosphere via drain passage 6 by negative pressure generated in the intake system during the operation of internal combustion engine 1, is introduced into the intake system of internal combustion engine 1 via purge passage 5, and then is finally combusted with fuel from a fuel injection valve in the inside of a combustion chamber of internal combustion engine 1.

Internal combustion engine 1 illustrated in the drawings is a four-stroke cycle spark ignition type engine, and is provided, for example, with a turbocharger 11 as a supercharger. Therefore Intake passage 7 of internal combustion engine 1 is provided with a compressor 11A for turbocharger, and a water cooling intercooler 12 and a throttle valve 13 are disposed more on the downstream side than compressor 11A. In addition, an admission valve 14 formed, for example, by a butterfly valve for generating negative pressure inside intake passage 7 is disposed more on the upstream side than compressor 11A in intake passage 7. A distal end of purge passage 5 is connected to intake passage 7 at a position between admission valve 14 and compressor 11A. Therefore negative pressure is generated by the action of admission valve 14 even in a supercharging area, and the purging of canister 3 by the pressure difference with the atmospheric pressure on the drain passage 6 side, namely, the introducing of purge gas to intake passage 7 can be performed.

In addition, a turbine 11B of turbocharger 11 is positioned on the relatively upstream side of an exhaust passage 15, and a catalyst apparatus 16 is provided more on the downstream side than turbine 11B. An air flow meter 17 is disposed more on the upstream side than admission valve 14 of intake passage 7.

Purge passage 5 is provided with a pair of purge control valves 8 formed by electromagnetic valves for controlling the flow rate of purge gas. Specifically, part of purge passage 5 branches into a pair of purge passages 5a and 5b arranged in parallel with each other, and a first purge control valve 8A and a second purge control valve 8B are respectively disposed thereto. That is, two purge control valves 8A and 8B are disposed so as to be arranged in parallel with each other. In the following, when it is not necessary to distinguish these two first and second purge control valves 8A and 8B, they are collectively referred to as purge control valves 8. In one embodiment, first purge control valve 8A and second purge control valve 8B are formed by electromagnetic valves which are basically the same type and have the same capacity. First purge control valve 8A and second purge control valve 8B may be electromagnetic valves having different capacity from each other.

Two purge control valves 8 are duty-controlled by engine controller 9. Engine controller 9 performs various controls of internal combustion engine 1 (fuel injection control, ignition control, opening degree control of throttle valve 13, opening degree control of admission valve 14, supercharging pressure control and the like are included). In addition, it performs purge control via purge control valves 8. Moreover, as will be mentioned below, engine controller 9 performs a fault diagnosis of a purge system including two purge control valves 8.

In one embodiment, two purge control valves 8 to be duty-controlled under the same drive frequency are controlled so as to be the same opening degree (that is, on-duty ratio), during the operation of internal combustion engine 1. In addition, in the present description, “opening control” means to operate purge control valves 8 at a proper on-duty ratio. In other words, it means to control the opening degree of purge control valves 8 by the duty control to a proper opening degree other than “0”. “Closing control” means to set the on-duty ratio to 0. Both of them do not mean to open/close purge control valves 8 at a pulse unit according to the drive frequency of the duty control. In this way, by controlling both of two purge control valves 8 into an open state at the time of the performing of the purging of canister 3, purge gas flows through two purge control valves 8 in parallel, and thereby the occurrence of pressure loss occurred in purge control valves 8 can be suppressed. Therefore, by the negative pressure generated by admission valve 14, a sufficient flow rate of the purge gas can be ensured.

On the other hand, as to the control at a drive pulse unit in the duty control, first purge control valve 8A and second purge control valve 8B are controlled to be open so as to have different phases from each other by 180 degrees. Consequently, when microscopically viewed, first purge control valve 8A and second purge control valve 8B are alternately opened/closed, and pressure pulsation generated in intake passage 7 and the like by the opening/closing of purge control valves 8 becomes small.

Purge passage 5 is provided with a pressure sensor 18 for detecting purge passage pressure. Specifically, pressure sensor 18 is provided within a range between purge port 3b of canister 3 and purge control valves 8 (preferably, a position closer to canister 3 than branching parts 5a and 5b), so as to detect the pressure inside purge passage 5 at a part closer to canister 3 than purge control valves 8. Therefore, in a state in which purge control valves 8 are controlled into an open state and purge gas flows from canister 3 to intake passage 7, negative pressure generate by admission valve 14 is introduced into purge passage 5, and the pressure detected by pressure sensor 18 (this pressure is referred to as “purge passage pressure”) is reduced toward a negative pressure side.

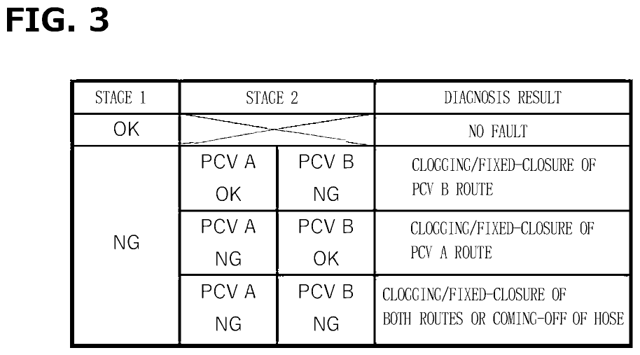

Next, the fault diagnosis for two purge control valves 8 will be explained. The illustrative view of FIG. 3 is one in which the processing of the fault diagnosis in one embodiment is collectively shown into a stage 1 in the left column, a stage 2 in the middle and the diagnosis result in the right column, and, as illustrated, when OK is determined (there is no abnormality) in the diagnosis of stage 1 (first diagnosis), the diagnosis of stage 2 (second diagnosis) is not performed and it is determined that there is no fault. When NG is determined (there is a fault) in the diagnosis of stage 1, the diagnosis of stage 2 is performed, and according to its result, the final diagnosis result is obtained, as mentioned below.

In this embodiment, the timing of diagnosis performance for the diagnosis of stage 1 is not specially set, and the diagnosis of stage 1 is intermittently performed (in other words, repeatedly performed) during ordinary traveling of the vehicle. In the diagnosis of stage 1, the purge passage pressure in a state in which two purge control valves 8 are both controlled to be open is read, and it is determined whether or not the purge passage pressure is equal to or lower than a first threshold value which is set on a negative pressure side. This diagnosis is performed under the condition in which the on-duty ratio in the opening control is equal to or higher than a predetermined diagnosis permission duty ratio (which is set to a relatively high value close, for example, to 100%). Then, when it is determined that the purge passage pressure under a state in which two purge control valves 8 are both controlled to be open is higher than the first threshold value, an NG counter is incremented. When the value of the NG counter reaches a predetermined value during intermittently performing the diagnosis of stage 1, the diagnosis result in stage 1 becomes NG, and then the diagnosis proceeds to the diagnosis of stage 2.

In the diagnosis of stage 2, two purge control valves 8 are controlled into an open state one by one, and it is determined whether or not the purge passage pressure under this state is equal to or lower than a second threshold value which is set on a negative pressure side.

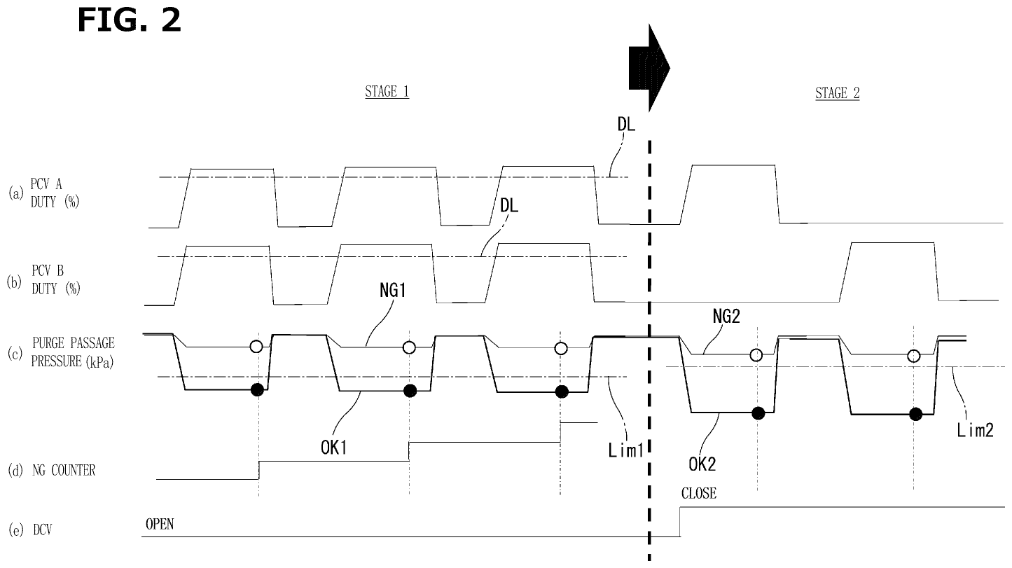

FIG. 2 is a time chart in which the diagnosis of stage 1 and the diagnosis of stage 2 are shown in a series to facilitate understanding. From the top, there are shown (a) the on-duty ratio of first purge control valve 8A (in the drawings, it is abbreviated to PCVA), (b) the on-duty ratio of second purge control valve 8B (in the drawings, it is abbreviated to PCVB), (c) the purge passage pressure (kPa), (d) an NG counter value, (e) the opening/closing state of drain cut valve 10 (in the drawings, it is abbreviated to DCV).

In the diagnosis of stage 1 shown in the former part of the time chart in FIG. 2, as illustrated, since first purge control valve 8A and second purge control valve 8B are simultaneously controlled into an open sate at an on-duty ratio close to 100% with the intermittent operation of internal combustion engine 1 according to an electric power request and the like, the purge passage pressure at that time is compared to a first threshold value Lim1. When first purge control valve 8A and second purge control valve 8B are normally operated, as shown in a line of OK1 in column (c), the purge passage pressure is relatively largely reduced, and becomes first threshold value Lim1 or lower. In contrast to this, when, as shown in a line of NG1, the purge passage pressure is higher than first threshold value Lim1, the NG counter shown in column (d) is incremented. Here, in consideration of a delay in pressure change, the purge passage pressure after a lapse of a proper delay period of time from the start of the opening control of purge control valves 8 is read, then is compared to first threshold value Lim1. In addition, as shown in column (e), at the time of the diagnosis of stage 1, drain cut valve 10 is being opened. In other words, the diagnosis of stage 1 is performed during performing normal purge.

As mentioned above, since the illustrated embodiment is one for internal combustion engine 1 for generating power in a series hybrid vehicle, the operation of internal combustion engine 1 is intermittently performed. In the time chart in FIG. 2, the increase/decrease change of the on-duty ratio shown in columns (a) and (b) corresponds to the intermittent operation of internal combustion engine 1. In the illustration, since internal combustion engine 1 is operated under a specific operation condition (load and rotation speed) of becoming the best fuel consumption point at the time of the operation of internal combustion engine 1, the on-duty ratio is basically a substantially fixed value such as 100% or a value close to 100%. During the stop of internal combustion engine 1, the on-duty ratio is 0. The on-duty ratio might be a lower value according to the operation condition of internal combustion engine 1, and if the on-duty ratio becomes a value lower than a diagnosis permission duty ratio DL, the diagnosis of stage 1 is not performed. In this way, the diagnosis is performed only when the on-duty ratio is equal to or higher than diagnosis permission duty ratio DL, the occurrence of wrong diagnosis due to a difference of the on-duty ratio can be avoided.

In an embodiment of FIG. 2, in the diagnosis of stage 1, it is determined that the purge passage pressure is equal to or lower than first threshold value Lim1 at every operation of internal combustion engine 1, and the NG counter is increased and reaches a predetermined value (in the illustration, it is set to 3 for explanation), and it is determined that some faults occur in the purge system, and then the diagnosis proceeds to the diagnosis of stage 2. In addition, the value of the NG counter may be reset at the point of the operation finish (trip finish) of the vehicle, or may be kept. By appropriately setting the NG counter value, it is possible to suppress excessive and frequent proceeding to the diagnosis of stage 2 due to some erroneous detection.

In the diagnosis of stage 2, as shown in column (e), drain cut valve 10 is closed, and, as shown in column (a) and column (b), first purge control valve 8A and second purge control valve 8B are forcibly controlled into an open state one by one at a fixed relatively high on-duty ratio (for example, 100% or a value close to 100%). That is, in a state in which the on-duty ratio of second purge control valve 8B is set to 0, the on-duty ratio of first purge control valve 8A is set, for example, to 100%. Then, the purge passage pressure is read after a lapse of a proper delay period of time in consideration of a delay in pressure change, and then is compared to a second threshold value Lim2 which is set on a negative pressure side. Next, in a state in which the on-duty ratio of first purge control valve 8A is set to 0, the on-duty ratio of second purge control valve 8B is set, for example, to 100%. Then, the purge passage pressure is read after a lapse of a proper delay period of time, and then is compared to second threshold value Lim2 which is set on a negative pressure side.

In addition, the diagnosis of stage 2 is performed during the operation of internal combustion engine 1 which is intermittently operated (that is, it is performed under a condition in which negative pressure is generated in intake pressure 7). The operation of internal combustion engine 1 may be positively requested to perform the diagnosis of stage 2.

When purge control valves 8A and 8B are correctly operated and negative pressure is introduced from intake passage 7 into purge passage 5, as shown in a line of OK2 in column (c), the purge passage pressure is relatively largely reduced, and then becomes second threshold value Lim2 or lower. In contrast to this, when the purge passage pressure is higher than second threshold value Lim2 as shown in a line of NG2, abnormality is determined.

In one embodiment, in consideration of closing of one of purge control valves 8, second threshold value Lim2 is set to a pressure higher than that of first threshold value Lim 1 (it is set to a negative pressure much closer to the atmospheric pressure). However, the present invention is not limited to this, and it can be appropriately set in consideration of various conditions at the time of diagnosis.

In addition, in the above embodiment, the purge system including canister 3 becomes a closing state by closing drain cut valve 10 at the time of the diagnosis of stage 2, and negative pressure is introduced into the closed purge system via purge control valves 8. Consequently, a decrease in the purge passage pressure when purge control valves 8 and the like are normal is more surely generated. For example, even in a case where the negative pressure generated by admission valve 14 is relatively insufficient, the accuracy of the diagnosis can be highly obtained.

In addition, as shown in FIG. 2, in the diagnosis of stage 2 in the illustration, although the forcible open operation of first purge control valve 8A and the forcible open operation of second purge control valve 8B are each performed only one time to determine the presence of a fault, the final determination for the presence of a fault may be performed by repeatedly performing the open control of each of first purge control valve 8A and second purge control valve 8B and the pressure determination a plurality of times.

Next, based on the illustrative view of FIG. 3, a diagnosis result which is finally obtained will be explained. First, when there is no fault in the diagnosis of stage 1, namely, when the purge passage pressure is equal to or lower than first threshold value Lim1, as mentioned above, it is determined that there is no fault, as a final diagnosis, without performing the diagnosis of stage 2. On the other hand, when it is determined that there are some faults (NG counter value reaches a predetermined value) in the diagnosis of stage 1, as mentioned above, the diagnosis of stage 2 is performed. In the diagnosis of stage 2, unless there is no wrong diagnosis due to some factors, the diagnosis result is any one of a case where the result of the diagnosis for first purge control valve 8A is normal and the result of the diagnosis for second purge control valve 8B is abnormal, a case where the result of the diagnosis for second purge control valve 8B is normal and the result of the diagnosis for first purge control valve 8A is abnormal, and a case where the result of the diagnosis for first purge control valve 8A and the result of the diagnosis for second purge control valve 8B are both abnormal.

As shown in FIG. 3, when, in the diagnosis of stage 2, normality (OK) is determined in the diagnosis for first purge control valve 8A and abnormality (NG) is determined in the diagnosis for second purge control valve 8B, it is finally diagnosed that fixed-closure of second purge control valve 8B or clogging of the passage (purge passage 5b) before and behind second purge control valve 8B occurs. When, in the diagnosis of stage 2, normality (OK) is determined in the diagnosis for second purge control valve 8B and abnormality (NG) is determined in the diagnosis for first purge control valve 8A, it is finally diagnosed that fixed-closure of first purge control valve 8A or clogging of the passage (purge passage 5a) before and behind first purge control valve 8A occurs. When, in the diagnosis of stage 2, abnormality (NG) is determined in both of the diagnosis for first purge control valve 8A and the diagnosis for second purge control valve 8B, it is finally diagnosed that clogging of both of purge passages 5a and 5b (or part of purge passage 5 which does not branch), fixed-closure of two purge control valves 8, or leakage of the purge system (that is, flowing-in of the atmosphere) due to coming-off of a hose and the like occurs.

In case of any faults, a fault code corresponding to each fault is generated and is held in a memory of engine controller 9. In addition, in order to inform a fault, for example, a warning lamp in a driver's seat is turned on.

In this way, in the fault diagnosis in the above embodiment, although the diagnosis of stage 1 is performed during normal operation of internal combustion engine 1, purging from canister 3 is continued as usual in the diagnosis of stage 1. Then, since the diagnosis of stage 2 is not performed until it is diagnosed that there are some faults in the diagnosis in stage 1, purging from canister 3 is not lost by the fault diagnosis.

In addition, in a series hybrid vehicle in which the frequency of the operation of internal combustion engine 1 is low, since the opportunity of the purging of canister 3 is low, it is not preferable to lose the purging by fault diagnosis. In the fault diagnosis in the above embodiment, an effect on the purging is basically low.

As the above, although one embodiment of the present invention has been explained in detail, the present invention is not limited to the above embodiment, and various changes might be made to the embodiment. In the above embodiment, although an embodiment applied to an internal combustion engine for generating power in a series hybrid vehicle has been explained, this invention can be similarly applied to a vehicle other than series hybrid vehicles, namely, a vehicle in which an internal combustion engine is used as a driving source for vehicle traveling. In addition, it can be similarly applied to a vehicle in which three or more purge control valves are provided. Further, if an internal combustion engine is a non-supercharging type internal combustion engine, negative pressure generated on the downstream side of a throttle valve can be used.

1. A fault diagnosis method for an evaporated fuel processing device in which a plurality of purge control valves are disposed in a purge passage between a canister and an intake system of an internal combustion engine so as to be arranged in parallel with each other, the method comprising:
performing a first diagnosis for a purge system based on a pressure of the purge passage at a time when the plurality of the purge control valves are all controlled into an open state; and
performing, by controlling the plurality of the purge control valves into an open state one by one, a second diagnosis for identifying a fault location based on the pressure of the purge passage in each state, when a fault is determined in the purge system in the first diagnosis.

2. The fault diagnosis method for the evaporated fuel processing device according to claim 1, wherein, in the first diagnosis, a fault is determined when the pressure of the purge passage is higher than a first threshold value on a negative pressure side,
wherein, in the second diagnosis, a fault is determined when the pressure of the purge passage is higher than a second threshold value on a negative pressure side, and
wherein the first threshold value is set to a pressure lower than that of the second threshold value.

3. The fault diagnosis method for the evaporated fuel processing device according to claim 1, wherein the first diagnosis is performed under a condition in which an on-duty ratio of each of the purge control valves is equal to or higher than a diagnosis permission duty ratio.

4. The fault diagnosis method for the evaporated fuel processing device according to claim 1, wherein, in the second diagnosis, when the pressure of the purge passage at a time when one of the purge control valves is controlled into an open state is abnormal and the pressure of the purge passage at a time when others of the purge control valves is not abnormal, it is identified that the one of the purge control valves has a fault.

5. The fault diagnosis method for the evaporated fuel processing device according to claim 1, wherein, in the second diagnosis, when the pressure of the purge passage at a time when all of the purge control valves are controlled into an open state is abnormal, it is identified that all of the purge control valves have faults or leakage of the purge passage occurs.

6. The fault diagnosis method for the evaporated fuel processing device according to claim 1, wherein, at a time of the performing of the second diagnosis, a drain passage of the canister is set to a closing state.

7. A fault diagnosis device for an evaporated fuel processing device, comprising:
a canister having a charge port connected to a fuel tank;
a purge passage which connects a purge port of the canister with an intake system of an internal combustion engine, and is provided with a plurality of purge control valves arranged in parallel with each other; and
a pressure sensor provided in the purge passage,
wherein a first diagnosis for a purge system is performed based on a pressure of the purge passage at a time when the plurality of the purge control valves are all controlled into an open state, and
wherein a second diagnosis for identifying a fault location is performed, by controlling the plurality of the purge control valves into an open state one by one, based on the pressure of the purge passage in each state, when a fault is determined in the purge system in the first diagnosis.
